(19) United States
(12) Patent Application Publication
(10) Pub. No.: US 2008/0066358 A1
(43) Pub. Date: Mar. 20, 2008

(54) HANDHELD ELECTRONIC DEVICE WITH A SUBSTANTIALLY SEMICIRCULAR SPRING CLIP ASSEMBLY AND AN ADVERTISING METHOD

(76) Inventor: Dilip Bhavnani, Beverly Hills, CA (US)

Correspondence Address: THE SONI LAW FIRM, 55 S. LAKE AVE SUITE 720, PASADENA, CA, 91101, US

(21) Appl. No.: 11/692,585

(22) Filed: Mar. 28, 2007

Related U.S. Application Data
(63) Continuation of application No. 10/754,154, filed on Jan. 9, 2004, now Pat. No. 7,217,031.

(51) Int. Cl. G09F 3/18

(52) U.S. Cl. 40/658; 24/3.12; 368/316; 40/666

(57) ABSTRACT

A device having a handheld device housing with a compartment formed therein, a substantially semicircular clip assembly for securely attaching thereby the device housing to an external cylindrical object such as stethoscope tubing, electric circuitry encased within the compartment, and at least one control unit formed on the device housing. The clip assembly may include a helical coil spring for biasing the substantially semicircular clip against the device housing. In the preferred embodiment, the electric circuitry may be of a digital alarming timer clock. The present invention also contemplates a method of advertising where multicolored advertising material may be disposed upon the device housing.

### CROSS-REFERENCE TO RELATED APPLICATIONS

This application claims priority to and is a continuation of co-pending application Ser. No. 10/754,154 filed on Jan. 9, 2004 and hereby claims the benefit thereof.

### BACKGROUND OF THE INVENTION

The present invention relates to a device housing encasing an electrical device, such as a digital clock, and having a substantially semicircular clip assembly formed on a rear surface thereof for releasably clipping an elongated cylindrical object such as a stethoscope tube. The present invention also relates to a method of advertising wherein the device housing is used as an advertising vehicle by disposing advertising material on an outer surface of the device housing.

Digital clocks with a LCD display have been known for many years. These clocks are common on watches and kitchen timers. These devices commonly incorporate a flat clip attached on the back of the housing in order to removably secure the device to an external object. In addition to clocks, various other devices, such as pens, digital devices, pagers, and telephones often include clips for the same purpose.

Typically the structure of clips is straight and flat. Such clips are designed to attach the device to flat objects such as shirt pockets, belts, and car visors. Many of these types of clips have a spring biased mechanism that allows the clip to open and close, facilitating the application and removal of the associated device. Examples of these types of flat clips are disclosed in U.S. Pat. No. 276,512 to Webster, U.S. Pat. No. 5,075,931 to van Kuijk, U.S. Pat. No. 5,361,459 to Hyvonen, and U.S. Pat. No. 5,678,281 to Kamp. A problem with these types of flat clips is that they do not work well, if at all, when used to secure a device to a cylindrically shaped object, for example, tubing or hoses. The tubing, when clipped under such clips, is easily dislodged from the clip, and further, may be undesirably compressed by the flat spring biased surface of the clips.

There are other clips that are designed to secure to cylindrically shaped objects, for example, tubing and hoses. Circular hose clips as disclosed for example in U.S. Pa. No. 6,389,650 to Yamada and in U.S. Pat. No. 5,309,607 to Hohmann. These are not designed to be integrated into a device housing. Furthermore, although these may grip a hose or tubing, they are not readily removable without tools. Therefore these hose clamps are inappropriate for attaching an associated device housing. Another type of clip for holding a tube is a shaped pre-bent single piece of resilient metal or plastic such as that disclosed in U.S. Pat. No. 6,507,267 to Russell. Similarly, U.S. Pat. No. 4,707,906 to Posey discloses a tube holder made from a narrow, elongated, thin, flat, semi-rigid strip of pre-bent spring metal such as stainless steel that is adapted for use with a given standard size hospital tubing. Those types of clips are without any coiled spring biasing mechanism and operate merely by leaf spring type biasing of a pre-bent metal strip. As such, they can be difficult to place and remove, may compress the tubing, usually fit only one particular diameter of tubing, and may fail early due to metal fatigue. Another type of specialty clip is the carabineer. U.S. Pat. No. 6,527,438 discloses a carabineer incorporation a timekeeping functionality. A carabineer however would not hold securely to a cylindrically shaped object.

What is lacking in the prior art is a device that will securely and removably attach a device housing to a cylindrically shaped external object such as tubing.

### SUMMARY OF THE INVENTION

It is accordingly an object of the present invention to provide a clip that securely and removably attaches a device housing to an external cylindrically shaped object.

Another object of the present invention is to provide a clip that is easily attached and removed from an external cylindrically shaped object without tools or excessive force.

It is yet another object of the present invention to provide a clip that will not unnecessarily and undesirably compress ,and thus potentially impair, soft rubber cylindrical tubing.

Still another object of this invention is to provide a spring biased clip upon a digital clock housing, that will permit the housing to be removably secured to stethoscope tubing without compressing the tubing or impairing the functioning of the stethoscope.

Yet another object of this invention is to provide an inexpensive way to place multicolor advertising upon a device housing to attract the attention of the user and other viewers.

These objects of this invention are accomplished by providing a spring biased clip attached to a device housing. In the preferred embodiment, the device housing incorporates a digital clock.

The device housing with a clip assembly of the present invention has a substantially semicircular rigid clip pivotally connected, at an end, to the flat back of the device housing with its substantially semicircular body positioned substantially perpendicularly to the back of the housing so that an opposing end can pivotally move between an open position and a closed position. The clip is resiliently biased against the housing such that, in the closed position, the clip body and the back of the housing forms a substantially semicircular clipping aperture therebetween, whereby a generally tube-shaped article can be releasably clipped therebetween perpendicularly through the substantially semicircular clipping aperture. The device housing may have advertising material on an outer surface thereof, or a multicolor advertising insert may be placed on the housing, and thereon, a transparent protecting cover may attach.

### BRIEF DESCRIPTION OF THE DRAWINGS

The foregoing objects, features, advantages and preferred embodiments of the device and method of the present invention will be better understood from the following detailed description taken in conjunction with the accompanying drawings in which:

FIG. 1 is an exploded prospective view of the present invention demonstrating the placement of advertising between a device housing and a fitted transparent advertising cover;

FIG. 2 is a top view of the assembled preferred embodiment of the present invention;

FIG. 3 is a side exploded view of the preferred embodiment of the present invention illustrating a generally semicircular clip and the fitted transparent advertising cover;

FIG. 4 is a posterior view of the generally semicircular clip assembled to the device housing of the preferred embodiment;

FIG. 5 is an anterior view of the clip assembled to the housing of the preferred embodiment; and

FIG. 6 is a rear view of the housing of the preferred embodiment illustrating the generally semicircular clip disassembled from the housing.

### DETAILED DESCRIPTION OF THE INVENTION

The accompanying Figures depict embodiments of the present invention, and features and components thereof. With regard to means for fastening, mounting, attaching or connecting the components of the present invention to form the apparatus as a whole, unless specifically described otherwise, such means are intended to encompass conventional fasteners such as machine screws, machine threads, snap rings, hose clamps such as screw clamps and the like, rivets, nuts and bolts, toggles, pins and the like. Components may also be connected by friction fitting, or by welding or deformation, if appropriate. Unless specifically otherwise disclosed or taught, materials for making components of the present invention are selected from appropriate materials such as metal, metallic alloys, natural or synthetic fibers, plastics and the like, and appropriate manufacturing or production methods including casting, extruding, molding and machining may be used. Any references to front and back, right and left, top and bottom, upper and lower, and horizontal and vertical are intended for convenience of description, not to limit the present invention or its components to any one positional or spacial orientation.

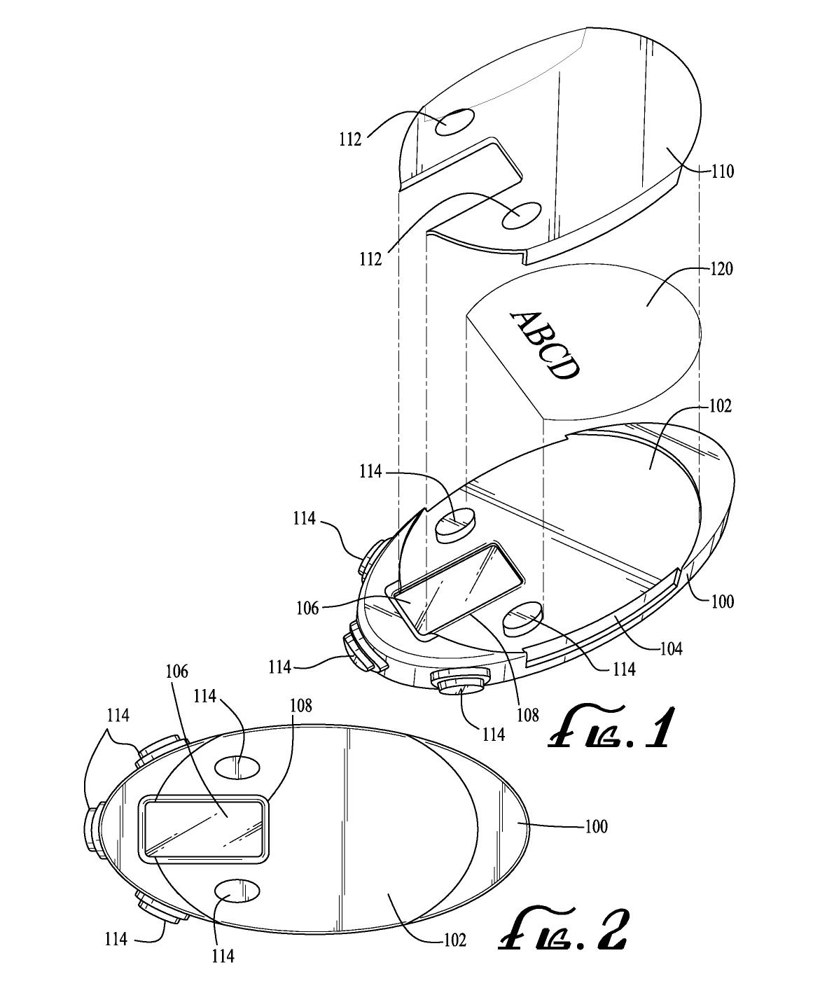

Referring to the drawings, FIG. 1 shows an exploded view of a device housing 100 of the present invention. The device housing 100 is fabricated of, preferably, plastic material and has a generally thin and oblong shape. However the housing in other embodiments may be fabricated from various other solid or semi-solid materials and have various other shapes, sizes, and colors. As shown in FIGS. 5 and 6, the device housing 100 is comprised of, in the preferred embodiment, a generally flat rear housing section 130 and an opposing front housing section 140 that are attached to each other to define a compartment (not shown) therebetween for encasing electrical circuitry of a particular electrical device. The two housing sections are attached in the preferred embodiment via housing screws 135 as shown in FIG. 6, but may be snap-fitted or glued together in another embodiment.

In the preferred embodiment, the device housing 100 encases a timekeeping functionality, more specifically a digital alarm clock and timer (not shown) in the compartment. Details of the structure and function of the inner electrical and/or mechanical components constituting such a digital alarm clock and timer are well known by one skilled in the art, and thus, not described herein further. It should also be understood that the timekeeping functionality could be an analog clock in another embodiment, and further, various other kinds of electrical devices such as pagers, and flashlights, may be instead encased within the device housing 100.

In the preferred embodiment a molded depression 102, defined on the front housing section 140 of the device housing 100, accommodates a fitted transparent advertising cover 110. The advertising cover 110 may have openings 112 for fitting a LCD panel and various function switches 114 therein. The advertising cover 110 snap-fits into indentations 104 formed on the sides of the device housing 100. An advertising insert 120, preferably in multicolor and with various indicia upon it, may be removably placed between the transparent advertising cover 110 and the front housing section 140 of the device housing 100, wherein the advertising is displayed. The transparent advertising cover 110 may alternatively be securely attached into position with glue or screws, in order to discourage the advertising insert 120 from being removed.

Referring also now to FIG. 2, the components of the digital alarm clock/timer in this preferred embodiment may include a LCD display panel 106. A sound emitting piezoelectric diaphragm may be included within the device housing 100. The LCD display panel 106 fits in, and is displayed through, a rectangular opening 108 defined on the front housing section 140 of the housing 100. In this preferred embodiment, there are other openings in the housing to accommodate the passage of electrical push button switches 114 provided to program the digital alarm clock/timer. An LED light may also be incorporated in the housing 100 to illuminate the LCD display 106.

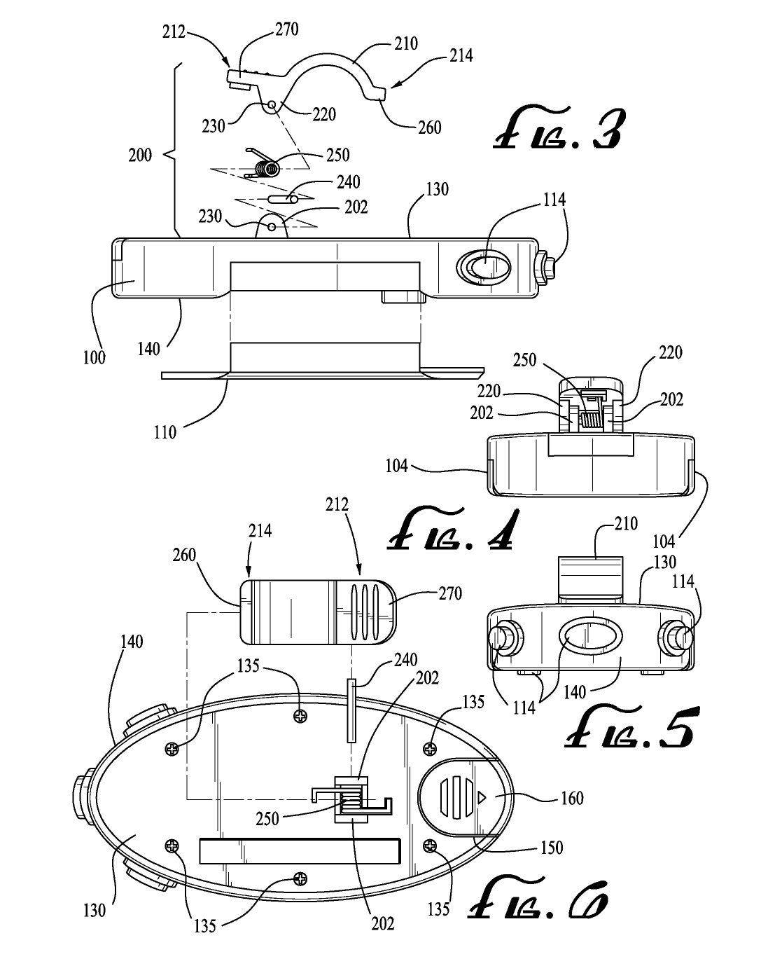

As shown in FIG. 3 and FIG. 4, a clip assembly 200 is mounted on the rear housing section 130. The clip assembly 200, in the preferred embodiment, comprises: a pair of housing flanges 202 that are perpendicularly protruding from, and integrally formed on, the rear housing section 130; a generally semicircular rigid clip 210 having a proximal end 212 and a distal end 214. Adjacent the proximal end 212 of the generally semicircular rigid clip 210 are formed a pair of clip flanges 220 for pivotally engaging the housing flanges 202. For such pivotal engagement, an axially aligned hole 230, defined in each of the clip flanges 220 and the housing flanges 202, accepts a transversely positioned guide pin 240. With the guide pin 240 in place, the clip 210 may pivotally rotate upon the rear housing section 130. A helical coil spring 250, surrounding the outside of the guide pin 240 and located between the two housing flanges 202, biases the distal end 214 of the generally semicircular rigid clip 210 against the rear housing section 130. One end of the helical coil spring 250 contacts the rear housing section 130 and the other end contacts the generally semicircular rigid clip 210. Additionally, in the preferred embodiment, on the distal end 214 of the generally semicircular rigid clip 210 is formed a foot plate 260, and extending from the proximal end 212 of the clip is a leverage arm 270.

Although the above clip assembly 200 is used, in the preferred embodiment, upon a device housing encasing a timekeeping device such as a digital alarm clock/timer, those skilled in the art will readily recognize that this clip assembly may also be connected with pens, pagers, name tags, signs, tags, and other devices, wherever attachment to a cylindrical object such as a pole, hose, or tube is desired.

In the preferred embodiment, the rigid clip has a substantially semicircular shape. However, the present invention contemplates in other embodiments rigid clips of various other shapes, for example, arched, humped, or other angled shapes with an angle less than 180 degrees on the side of the clip closest to the housing, as long as such shaped clips are capable of accommodating, without compressing, cylindrically shaped tubing.

The device housing 100, in this preferred embodiment, also includes a removable power supply, for example a watch battery. As shown in FIG. 6, a battery access port 150 and a removable battery cover 160 may be formed on the rear housing section 130, whereby the battery (not shown) retained therein may be changed.

The present invention also includes a method of advertising upon a device housing. The method comprises the steps of providing a device housing having a substantially semicircular clip assembly as described above and disposing advertising indicia upon, preferably, the front housing section 140 of the device housing 100, and removably attaching a transparent cover upon the advertising indicia so that the advertising indicia is visible therethrough. In the preferred embodiment, the step of disposing advertising indicia may comprise the steps of preparing an insert 120, imprinting multi-colored advertising indicia upon the insert 120, and placing the insert 120 upon the front housing section 140 of the device housing 100.

As will be realized, the invention is capable of other and different embodiments, and its several details are capable of modifications that are apparent to those of ordinary skill in the art, all without departing from the invention. Accordingly, the drawings and description are to be regarded as illustrative in nature, and not as restrictive.

What is claimed is:

1. A portable device-clip assembly for attachment to a generally tube-shaped article, the device-clip assembly comprising:
(a) a portable handheld device housing comprising a rear housing section and a substantially opposed front housing section, the sections being connected together to define a compartment bounded thereby;
(b) a substantially semicircular rigid clip having a distal clip end, a proximal clip end, and a substantially semicircular clip body, the proximal clip end being pivotally connected to the rear housing section;
(c) a biasing member disposed between the clip and the rear housing section for resiliently biasing the distal clip end toward the rear housing section to define a substantially semicircular clipping aperture between the clip body and the rear housing section for selectively releasably receiving the generally tube-shaped article therethrough;
(d) electric circuitry encased within the compartment; and
(e) at least one input unit formed on an outer surface of the device housing for controlling the electric circuitry.

2. The device-clip assembly as in claim 1, wherein the substantially semicircular rigid clip further includes a foot plate and a leverage arm.

3. The device-clip assembly as in claim 1, wherein the front housing section defines an advertising portion on an outer surface thereof, and the device housing further comprises:
(a) a transparent advertising cover disposed upon the advertising portion; and
(b) advertising indicia disposed between the transparent advertising cover and the advertising portion of the front housing section of the device housing.

4. The device-clip assembly as in claim 3, wherein the advertising portion has a greater area than the rest of the outer surface of the front housing section.

5. The device-clip assembly as in claim 4, wherein the device housing further comprises an insert disposed between the transparent advertising cover and the advertising portion, and the advertising indicia is imprinted upon the insert.

6. The device-clip assembly as in claim 3, wherein the advertising portion is a recess having a depth substantially conforming to the thickness of the transparent cover.

7. The device-clip assembly as in claim 1, wherein the electric circuitry includes a digital alarm clock and timer.

8. The device-clip assembly as in claim 7, further comprising a removable battery disposed within the housing for providing power to the electric circuitry.

9. The device-clip assembly as in claim 8, wherein the device housing-clip assembly further comprises a LCD panel for displaying digital signals generated by the clock and timer, and the front housing section defines on an LCD window an outer surface thereof sized and configured to fit the LCD panel therein.

10. The device-clip assembly as in claim 9, wherein the substantially semicircular rigid clip further includes a foot plate and a leverage arm.

11. The device-clip assembly as in claim 9, wherein the front housing section further defines an advertising portion on the outer surface thereof and the device housing further comprises:
(a) a transparent advertising cover disposed upon the advertising portion; and
(b) advertising indicia disposed between the transparent advertising cover and the advertising portion of the front housing section of the device housing.

12. The device-clip assembly as in claim 11, wherein the advertising portion has a greater area than the rest of the outer surface of the front housing section.

13. The device-clip assembly as in claim 12, wherein the advertising portion is a recess having a depth substantially conforming to the thickness of the transparent cover.

14. The device-clip assembly as in claim 13, wherein the device housing further comprises an insert disposed between the transparent advertising cover and the recess, and the advertising indicia is imprinted upon the insert.

15. The device-clip assembly as in claim 11, wherein the advertising indicia is oriented in an opposite direction with respect to the digital signals displayed on the LCD panel.

16. A method of advertising and promotion comprising the steps of:
(a) providing a device-clip assembly for attachment to a generally tube-shaped article, the device-clip assembly comprising:
(1) a portable handheld device housing comprising a rear housing section and a substantially opposed front housing section, the sections being connected together to define a compartment bounded thereby,
(2) a substantially semicircular rigid clip having a distal clip end, a proximal clip end, and a substantially semicircular clip body, the proximal clip end being pivotally connected to the rear housing section,
(3) a biasing member disposed between the clip and the rear housing section for resiliently biasing the distal clip end toward the rear housing section to define a substantially semicircular clipping aperture between the clip body and the rear housing section for selectively releasably receiving the generally tube-shaped article therethrough,
(4) electric circuitry encased within the compartment, and
(5) at least one input unit formed on an outer surface of the device housing for controlling the electric circuitry;
(b) preparing a transparent advertising cover;
(c) disposing advertising indicia upon the advertising portion of the front housing section; and
(d) removably attaching the transparent cover upon the front housing section such that the advertising indicia are displayed through the transparent cover.

17. The method of advertising and promotion as in claim 16, wherein the advertising portion has a greater area than the rest of the outer surface of the front housing section.

18. The method of advertising and promotion as in claim 16, wherein the step of disposing advertising indicia comprises the steps of:
(a) preparing an insert;
(b) imprinting advertising indicia upon the insert; and
(c) placing the insert upon the advertising portion of the front housing section.
